(19) United States
(12) Patent Application Publication
(10) Pub. No.: US 2026/0030595 A1
(43) Pub. Date: Jan. 29, 2026

(54) SYSTEMS AND METHODS FOR EMPLOYEE REWARD AND RETENTION VIA CUSTOMIZABLE FINANCIAL ACCOUNTS

(71) Applicant: Ezra Financial, Inc., San Francisco, CA (US)

(72) Inventors: Micah BERMAN, Oakland, CA (US); Dashell LARYEA, San Francisco, CA (US)

(21) Appl. No.: 19/278,309

(22) Filed: Jul. 23, 2025

Related U.S. Application Data
(60) Provisional application No. 63/674,622, filed on Jul. 23, 2024.

(51) Int. Cl. G06Q 10/1057; G06Q 10/0639; G06Q 40/12

(52) U.S. Cl. CPC G06Q 10/1057; G06Q 10/06398; G06Q 40/125

(57) ABSTRACT

The present disclosure is directed to systems and methods for workforce management via or using financial tools and technologies. Embodiments can provide ease of implementation and use while also incentivizing both employers and employees. In one embodiment, a computer-implemented system for workforce management is disclosed. The system can include at least one processor and memory comprising code configured to facilitate a payroll-linked savings system. In another embodiment, a computer-implemented method for workforce management by facilitating a payroll-linked savings system that utilizes at least one processor and memory is disclosed.

### PRIORITY

This application claims the benefit of U.S. Provisional Patent Application No. 63/674,622 filed on Jul. 23, 2024, the entirety of which is incorporated herein by reference.

### TECHNICAL FIELD

Embodiments of this disclosure relate generally to the field of financial technology and more particularly to workforce management via or using financial tools and technologies.

### BACKGROUND

Employers today face significant problems in recruiting, rewarding, and retaining employees. At the same time, employees face significant problems in meeting everyday emergency expenses, with more than half of Americans unable to afford a $500, one-time emergency expense in cash.

While emergency savings support is the single most-requested financial benefit by hourly workers in the U.S., few employers offer such a benefit to their employees. Those that do use systems built on antiquated infrastructure and divorced from the key measures that matter to any business. Meanwhile, employers also spend valuable resources on the consequences of the financial insecurity of their workforces, including the costs of firing good workers who miss work because of a sick child, a flat tire, or any other otherwise avoidable financial emergency.

Conventional approaches to addressing these problems lack the capability to tie an employer's actions and benefits packages to a clear return on investment via a measurable bottom-line revenue impact. Furthermore, payroll-linked and emergency savings mechanisms available today fail to solve two critical problems in any workforce management solution, both of which substantially hinder adoption, efficacy, and—eventually—the financial prosperity of the majority of America's employees. The first is ease of implementation and use, and the second is incentives.

### SUMMARY

A need exists, therefore, for systems and methods having a financial automation layer that helps employees achieve financial security, today and tomorrow-empowered by business-aligned support from their employers.

In one embodiment, a computer-implemented system for workforce management is disclosed. The system can comprise at least one processor and memory comprising code configured to facilitate a payroll-linked savings system by automatically identifying at least one workforce member eligible for the payroll-linked savings system in a workforce information system, authenticating the at least one eligible workforce member for enrollment in the payroll-linked savings system and establishing an account for the at least one eligible workforce member, presenting at least one possible contribution model to the at least one eligible workforce member, receiving a contribution election from the at least one eligible workforce member, diverting compensation of the at least one eligible workforce member to the established account according to the received contribution election, and offering a performance-based incentive to the at least one eligible workforce member, such that if performance is met by the at least one eligible workforce member, a contribution is made to the established account of the at least one workforce member by an employer.

In another embodiment, a computer-implemented method for workforce management by facilitating a payroll-linked savings system that utilizes at least one processor and memory is disclosed. The method can comprise receiving an automatic identification at least one workforce member eligible for the payroll-linked savings system from an employer workforce information system; authenticating the at least one eligible workforce member for enrollment in the payroll-linked savings system; causing an account for the at least one eligible workforce member to be established; presenting at least one possible contribution model to the at least one eligible workforce member; receiving a contribution election for the at least one eligible workforce member; causing compensation of the at least one eligible workforce member to be diverted to the established account according to the received contribution election, and facilitating presentation of a performance-based incentive to the at least one eligible workforce member, such that if performance is met by the at least one eligible workforce member, a contribution is made to the established account of the at least one workforce member by an employer.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

This disclosure may be more completely understood in consideration of the following description of various embodiments in connection with the accompanying figures, in which:

FIG. 1 is a block diagram of entity relationships that can be involved in embodiments of this disclosure.

FIG. 2 is a more detailed block diagram of entity relationship that can be involved in embodiments of this disclosure.

FIG. 3 is another block diagram of entity relationships that can be involved in embodiments of this disclosure.

FIG. 4A is an example screen capture of a user interface according to an embodiment of this disclosure.

FIG. 4B is another example screen capture of a user interface according to an embodiment of this disclosure.

FIG. 5 is an example diagram of prioritized funds routing according to an embodiment of this disclosure.

FIG. 6 is a flowchart according to an embodiment of this disclosure.

While various embodiments are amenable to various modifications and alternative forms, specifics thereof have been shown by way of example in the drawings and will be described in detail. It should be understood, however, that the intention is not to limit the disclosure or claims to the particular embodiments described. On the contrary, the intention is to cover all modifications, equivalents, and alternatives falling within the spirit and scope of the subject matter as defined by the claims.

### DETAILED DESCRIPTION

The present disclosure is directed to systems and methods for workforce management via or using financial tools and technologies. Embodiments address the aforementioned challenges by providing ease of implementation and use while also incentivizing both employers and employees. This can be done in many ways as discussed herein below, including via a payroll-linked savings system (PLSS) offered by an employer to employees, who may open and utilize emergency savings accounts (ESAs) or other accounts and other financial accounts and instruments in or via the PLSS.

The use of at least the terms “employer,” “employee,” and “bank” in this disclosure is intended to be broad. For example, an employer can be a corporation, an individual, a small business, a cooperative, or essentially any individual or organization that provides compensation, in any form, to an individual or group for performing some service. Similarly, an employee or workforce member can be a full-time employee, a part-time employee, a contractor, an hourly employee, a salaried employee, an individual paid on commission, or anyone who performs a service for an individual or organization and is somehow compensated in return. A bank can be any financial institution or group, including a brick-and-mortar bank, an online bank, an organization that provides accounts for short- or long-term savings (including those that are tax-advantaged, such as for retirement), an online bank, a crypto bank or arrangement, or any financial group or arrangement that offers accounts of any form into which a business or individual may deposit and withdrawal resources that are or can be converted into any type of currency.

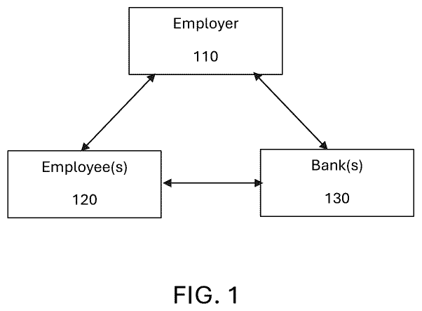

Referring to FIG. 1, high-level relationships or interactions between at least one business entity or employer 110, at least one workforce member or employee 120, and at least one financial institution or bank 130 are depicted. In some embodiments, additional relationships may be involved, such as between employer 110, one or more vendors (not depicted), and at least one bank 130. In still other embodiments, vendors may be effectively integrated with employer 120 or bank(s) 130 (or both). In yet another embodiment, and viewing interactions from the perspective of a particular employee 120, there also may be multiple employers 110 and multiple banks 130, such as in a situation in which one employee 120 has multiple jobs and therefore multiple employers 110, each with a relationship with at least one bank 130, which may or may not overlap. In practice, these relationships and interactions may be in person to some extent, but in many cases they are electronic or computer-based, facilitated via payroll and accounting systems, bank accounts, and credit/debit systems. Accordingly, FIG. 1 may be viewed either as a diagram of people or entities, or of respective computer systems that interact. For example, employer 110 may use a payroll system that transfers compensation to employee 120 via direct deposit to a checking account employee 120 has at bank 130. Though not depicted in FIG. 1, such an arrangement likely involves at least two banks, a bank of employer 110 and a bank of employee 120. Employee 120 then may access their bank account online, via a website on a computer, an application on a smartphone or tablet, or similar functionality powered by an application programming interface (API) embedded in a different system, to transfer funds, pay bills, or withdraw cash.

This is generally conventional, and setting up payroll, direct deposit, and other transactions in such an arrangement often uses antiquated interfaces and operations, both with respect to banks 130 and with employers 110. This can make setup and operation more difficult for all involved, which only becomes more complicated if an employer attempts to establish additional savings mechanisms for employee 120.

For example, many conventional employer-offered emergency savings programs require employees to manually open accounts, employers to provide a file of all eligible employees, and the bank or vendor in return to provide a file of registered deductions on the platform that must be manually ingested into each payroll run with final results returned to the bank or vendor. This tedious and slow exchange process is error-prone and introduces unneeded delay.

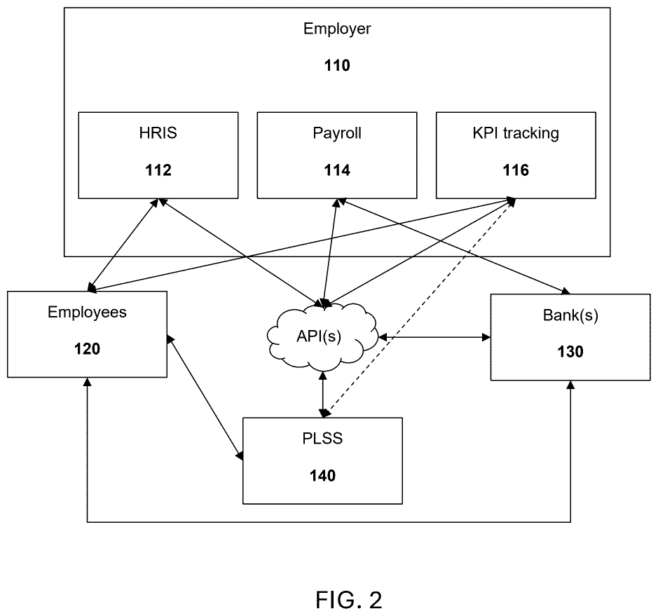

Thus, one embodiment of this disclosure can provide a PLSS and related methods that facilitate a simplified flow in which employers need not provide any additional information, such as passcodes or other employee data, directly to the PLSS. Referring to FIG. 2, embodiments of such a PLSS 140 can use an API interconnection to a human resources information system (HRIS) 112 and payroll system 114 to accomplish this. A key performance indicator (KPI) tracking module 116 may also be included.

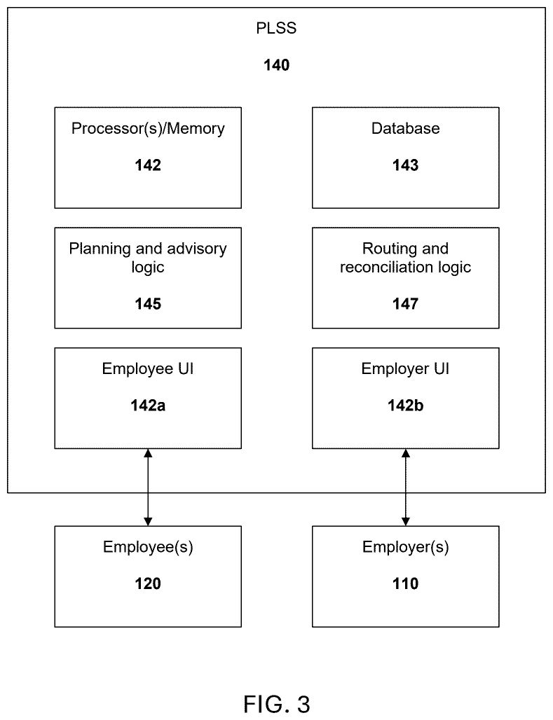

Referring also to FIG. 3, in various embodiments PLSS 140 comprises at least one processor and memory 142, at least one database 143, planning and advisory logic 145, and routing and reconciliation logic 147. In other embodiments, the systems and methods discussed herein can operate in conjunction with, rather than comprise, at least one processor and memory. For example, in one embodiment processor and memory 142 can be cloud-based, with user interaction facilitated via the internet, one or more APIs, and a user interface presented on a computing device, such as a computer, laptop, smart phone, tablet, smart watch or other wearable, or other device or system, or some other computing device portal.

Processor and memory 142, or any of the other systems or components discussed herein with respect to an underlying or implemented computer system, can be or work in cooperation with any programmable device (or system or network of devices) that accepts digital data as input, is configured to process the input according to instructions or algorithms, and provides results as outputs. In one example embodiment, at least one processor of processor and memory 142 can be a central processing unit (CPU) or a microcontroller or microprocessor (or group of microcontrollers or microprocessors) configured to carry out the instructions of a computer program or software. The at least one processor of processor and memory 142 therefore can be configured to perform at least basic arithmetical, logical, and input/output operations.

The memory of processor and memory 142 can comprise or be coupled with volatile or non-volatile memory as required by any of the processors to not only provide space to execute the instructions or algorithms but also to provide the space to store the instructions themselves. In various embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, or optical disc storage, for example.

The foregoing examples in no way limit the types of processing hardware or systems, or memory hardware or systems, that can be used in various embodiments, as these examples are given only by way of example and are not intended to limit the scope of the present disclosure or embodiments discussed herein. For example, both the processor and memory of PLSS 140 can be cloud-based but nevertheless comprise physical infrastructure on a server or server farm.

Additionally, though at least one processor and memory 142 is depicted as being distinct or separate from database 143, planning and advisory logic 145, and routing and reconciliation logic 147, in some embodiments various ones or all of these components (whether physical or functional) can be implemented by the same hardware or logic circuitry, or each may be independent. As such, the depictions in FIG. 3 and other figures herein can be considered to be conceptual or functional, instead or in addition to be structural or physical.

Returning to the overall view of FIG. 3, in one embodiment PLSS 140 can provide an employee portal 142a for employees 120 and an employer portal 142b for employers 110 of the employees 120 using the system. As such, PLSS 140 can be a vendor or third-party provider unaffiliated with employer 110, bank 130, or employee 120 in one embodiment. These portals 142a and 142b may be accessed via a computer, smart phone, tablet, or other computer device, such as via a web site/portal or in a mobile or desktop application.

In other embodiments, PLSS 140 may be part of, implemented by, affiliated with, or have some relationship with a bank 130. This bank can be bank 130, which may otherwise have a business relationship with at least one of employer 110 or employee 130, or it can be another, separate bank. Those skilled in the art will appreciate that actual communications or connection between PLSS 140 and bank 130 (as well as between employees 120 and PLSS 140) can be facilitated via an API, the web, traditional formatted file exchange, or some other network, in some embodiments.

In still other embodiments, PLSS 140 can be implemented entirely as a branded, API-powered inclusion within any other application (for example, that of a payroll system, insurance company, or other partner).

Regardless of whether these relationships exist or not, in the embodiment of FIG. 2 in which PLSS 140 uses an API to connect to HRIS 112 and 114, employer 110 can define eligibility of employees 120 by category available through HRIS 112 or payroll system 114 in one embodiment. In other embodiments, employer 110 can define eligibility of employee 120 via interaction with a user interface of, file exchanged with, or support team associated with PLSS 140.

Because PLSS 140 can programmatically connect systems (e.g., HRIS 112, payroll 114, KPI tracking 116, banking 130) and securely obtain reliable information therefrom, an individual user (employee 120) can be authenticated via a simple email sent to their e-mail address or a one-time-use code sent via SMS to a verified phone number. Moreover, a majority of the necessary data to achieve “know your customer” (KYC) compliance for any particular employee 120 may be retrieved from HRIS 112, payroll 114, or some other system of employer 110, making it expeditious for that employee 120 to open an ESA with PLSS 140 without re-entering information already held by employer 110. This improves ease of enrollment and implementation as compared with conventional approaches previously mentioned. Moreover, changes effected by any employee 120 via PLSS 140 can be, in turn, reflected in HRIS 112, payroll 114, or some other system of employer 110 as expediently, accurately, and reliably as possible via the API interface.

Also with respect to ease, almost any employee 120 can open a traditional savings account at the bank of their choice, log into the payroll system used by their employer 110, and elect to divert a portion of their pay to their savings account, continuing to manage the amount and frequency of those contributions over time. However, the fact that most Americans today cannot afford a common emergency expense suggests that most people do not do this.

Most savings programs provided by employers 110 for their employees 120 today provide a simple dollars-per-paycheck or percentage-per-paycheck deduction method. Each of these, however, usually fails to provide employee 110 with a sufficient understanding of the impact of a given contribution. Thus, various embodiments of PLSS 140 can model the impact of contribution amounts using historical payroll data for a particular employee 120 from previous pay cycles from one or more employers 110 and provide this modeling to employee 120. This enables employee 120 to consider this data and see a meaningful model of annualized contributions even with fluctuating hours. In addition, and if applicable, employee 120 can see the value of various contribution amounts alongside any outstanding debt, investments, and other assets the employee 120 may have.

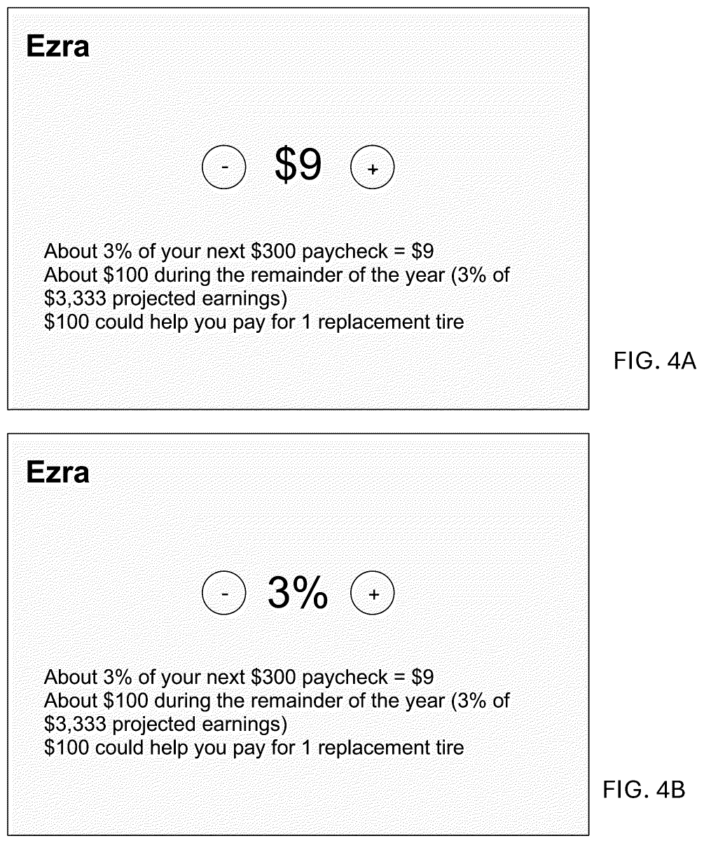

For example, and referring to the example user interface screenshots of FIGS. 4A and 4B, an employee 120 utilizing PLSS 140 could choose to contribute 3% of their paycheck (FIG. 4B). The example of FIG. 4A is similar but instead, at the highest level, depicts the contribution as a dollar amount rather than a percentage of pay. Based on this choice, employee 120 can see via PLSS 140 some or all of the following contextual factors (only some of which are depicted in FIGS. 4A and 4B): (i) the amount of contribution estimated in their next pay period (in this example, $9); (ii) the amount of contribution over the remainder of the year, based on an averaged total pay per period for the year-to-date (about $100 in this example); (iii) the purchasing power of this contribution against a future need (e.g., a new set of tires); and (iv) the impact of any contribution scenario on their overall financial wellbeing (e.g., interest payments avoided as a result of having savings available). In addition, contributions also can be contextualized relative to other employees at the same or other employers in amount, frequency, or other characteristics, providing additional information to the particular employee 120 as they make or adjust their contribution choices. In addition, in some embodiments, changes in contribution amount can be made by PLSS 140 automatically—for example, by increasing contribution amounts commensurate with increases in the salary of any eligible employee 120.

Using similar systems to estimate annualized figures as described in (ii) above, PLSS 140 can also integrate with other financial systems used by employee 120 to model annualized spending. Based on these models, PLSS 140 may show to employee 120 via employee portal 142 the amount of funds available for them to spend without impacting existing obligations, provided they continue to earn and spend at generally similar rates.

Another aspect of PLSS 140 is contextualizing potential withdrawals for employees 120. In one embodiment PLSS 140, via planning and advisory logic 145, can make clearer to employees the possible consequences of a withdrawal from their ESA. For example, in one embodiment PLSS 140 could show employee 120, via employee portal 142, the number of pay periods, at an average of previous contribution frequency and amount, it would take employee 120 to re-save the determined amount; the overall proportion of the annual contributions by employee 120 such a withdrawal represents; or a comparison to withdrawals (or lack thereof) made by other employees at the same or another employer, including those with similar pay or savings profiles.

Some embodiments of PLSS 140 can provide social nudging of employee contributions. For example, one embodiment of PLSS 140 can provide social nudges for an employee 120 to increase contributions by providing a comparison to similar or dissimilar employees at the same or different employer, and may include a specific dollar amount (“Senior Technician's like you save $20 more than this on average-want to increase?”). Some embodiments could include a social leaderboard or other aspect of open competition. In still other embodiments, social nudging and other features can be optional (i.e., what may nudge or encourage one person may discourage or increase stress or anxiety for another), such that each employee 120 or employer 130 may opt in or out of some of all of them.

Still other embodiments of PLSS 140 can use natural language processing (e.g., artificial intelligence) or other algorithms or rules to synthesize the context of withdrawals. For example, PLSS 140 can analyze employee-stated reasons (via, for example, text or audio input to employee portal 142) and the financial context and circumstances (for example, checking account balances, work performance or shift attendance, or other sources of financial information) of an emergency withdrawal, and provide back to the employer aggregated and deidentified insights about the potential cause and nature of the withdrawal. For example, if the stated reason for many employee 120 withdrawals is “needed a new set of tires” or similar, an insight provided by PLSS 140 to employer 110 might be “25% of withdrawals were for new tires, consider a tire purchase discount.”

Given that employee 120 may have a variety of emergency saving and financial goals and obligations, one embodiment of PLSS 140, via routing and reconciliation logic 147, can offer automatic redirection of savings across a broad scope of financial services. In one example, PLSS 140 can allow employee 120 to choose to automatically route contributions from a paycheck into multiple accounts. Target accounts may include savings, debt payoff, investments, and other financial products, vehicles, or assets.

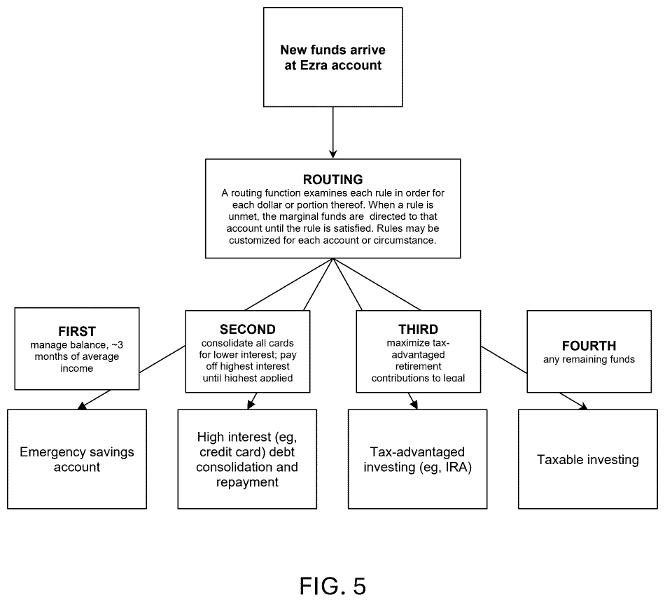

Referring to FIG. 5, for each additional dollar contributed by employee 120, planning and advisory logic 145 of PLSS 140 can evaluate and suggest the best disposition of that dollar given balances and goals across all accounts, knowledge of upcoming payroll runs, and any other factors available to PLSS 140. A goal of PLSS 140 here can be to implement broadly-prudent financial advice (for example, save for emergencies first, pay down high-interest debt second, contribute to tax-advantaged investing for retirement third, taxable investing or high-interest saving fourth) while incorporating and automatically operationalizing any additional information or context available to PLSS 140. This additional information may include past withdrawal or savings habits of employee 120, whether employee 120 has dependents, a demographic of employee 120, information from connected accounts, credit reports, tax status or withholding information, or information tangentially relevant to employee 120, such as that of coworkers, others with similar positions or titles at other employers, general financial trends, etc.

In addition, employee 120 can provide additional context or guidance to PLSS 140 via the employee portal 142 indicating specific circumstances relevant to their financial plan (for example, the desire to purchase real property in the next 5 years). PLSS 140 can then use this information in combination with the tangential and historical factors referenced above to customize fund routing.

PLSS 140 can operate by using a set of routing rules implemented by routing and reconciliation logic 147. One example of a routing rule is that the balance in an emergency savings account should remain at approximately X months of averaged income. Such a rule may be tailored over time to a profile of each employee 120 and analytically benchmarked against peers (e.g., those within a similar socio-economic bracket, job bracket, or geography) in order to inform and update the routing rules as well as the underlying algorithm. Thus, PLSS 140 may only route new funds as they arrive in the account, or may proactively rebalance existing funds already in one or more accounts across other accounts or dispositions, in some circumstances. The destinations of any given routing decision may be products or services operated as part of PLSS 140, employer 110, or into a product or service available through a partnership with another entity.

Employee mobility is also contemplated in embodiments of PLSS 140. Though this can vary according to state or other law, or employer 110 option, one embodiment of PLSS 140 can allow any individual employee 120 to continue to access their account in PLSS 140 even after they have departed any particular employer 110. When an employee 120 joins a new employer, employee 120 may be able to link their PLSS account to their new employer, provided that the new employer offers a similar PLSS service. In a similar vein, it may be possible for one employee to link their account to multiple employers to receive contributions from their pay, and incentive contributions where applicable, from each employer.

As can be seen, PLSS 140 provides many features in its various embodiments that improve ease of implementation and use for all parties as compared with conventional approaches. Furthermore, embodiments of PLSS 140 provide features not offered by conventional approaches to emergency savings.

Ease alone may not be enough to make PLSS program participation compelling to some employees 120, however. Thus, another feature of some embodiments of PLSS 140 is incentivization. In one embodiment, this can include an additional employer contribution on top of the contribution of employee 120, thereby providing an instant “return” on contributions that makes use of PLSS 140 more compelling for employees 120.

These incentives should also benefit the employer 110. However, conventional savings programs on the market today use savings-based goals (for example, if an employee saves at least $200, the employee will receive a $20 match from their employer). These models are suboptimal because the marginal value of an additional dollar saved by an employee is unknown to an employer; because the cost of additional employee savings is not tied to any material benefit to the employer providing the incentive contribution; and moreover, because it represents a bottom-line budget liability of unknown amount. In addition to being disconnected from what matters to the business of the employer, even the basic program design may become hard to justify: the marginal value of an employer match is unknown, and the marginal value of those additional employee savings are also unknown.

In short, it makes much more sense to fundamentally rethink the way in which incentives are structured in workforce management platforms. Instead of being a simple savings vehicle, emergency savings accounts such as those included in some embodiments of PLSS 140 can become powerful motivators for employee performance.

In one embodiment, an employer contribution (as an incentive or reward) can be made to the account of an employee 120 via PLSS 140 when the employee 120 has met conditions of an indicator that is material to the employer organization's performance. Referring again to FIG. 2, this can be implemented by or with KPI tracking module 116. Such an extrinsic trigger could be aligned with one or more KPIs that are most important to the employer 110, and, in one example, constructed in such a way that the amount paid is less than the value already accrued to the organization by the time such a reward is paid out.

Some embodiments may be able to directly access employee or company performance information directly from KPI tracking system 116. Examples of such KPI tracking systems 116 can include systems designed to track labor, timecards, attendance, compliance, hiring, onboarding, training, team communications, point-of-sale or other sales-tracking systems, inventory tracking systems, and other productivity management software. This information may be used as the trigger for employer incentive payments in near-real time due to programmatic integrations. However, when a programmatic integration is not possible or desired, similar information may be entered directly into an embodiment by the employee or employer via the PLSS 140, submitted to or otherwise accessed by the support team associated with PLSS 140.

While KPI-based incentives could support traditional dollar-on-dollar matching, some embodiments can also support many more forms of KPI-linked matching. For example, such a system may support matching schemes such as:
Traditional
   Payment per dollar saved ($0.50 per $1 saved, potentially subject to a maximum)
   Payment per contribution ($5 after saving at least $25 from a paycheck)
   Payment per savings milestone ($40 after saving at least $400 in total)·
Linked to employee performance
   Payment per longevity ($30 after 30 days, $60 after 60 days)
   Payment per peers ($50 awarded from peers)
   Payment per performance ($10 for meeting on-time performance, safety targets)
   Payment per referral ($50 for each coworker referred)·
Linked to employee scheduling or shift attendance
   Payment for agreeing to work any specific shift or part thereof, which is of particular value to the employer (e.g., agree to work this Saturday shift, get a $50 reward; pick up a shift canceled by a colleague at the last minute, get a $35 reward)
      Thus, in embodiments, the performance-based incentive is at least one of the following: an amount saved in the employee 120 account, a number of contributions made to the employee 120 account, a savings participation of a team or group that includes employee 120, an employment term of employee 120, a characteristic of a peer of employee 120, an unfilled shift covered by employee 120, an on-time performance of employee 120, an on-time performance of a team that includes employee 120, a sales goal attainment of employee 120 or a team that includes employee 120, an on-the-job performance metric related to performance of employee 120 or a team that includes employee 120, at least one customer service survey score or rating as achieved by employee 120 or a team that includes employee 120, a safety performance of employee 120, a safety performance of a team that includes employee 120, or a referral target met by employee 120. In embodiments, any of these examples as well as others can apply to individual employees 120 as well as any team or group that may include employee 120, where the team or group may be based on a formal team with respect to work responsibilities or a behind-the-scenes team or seemingly arbitrary team defined by employer 110 according to some characteristic or reason.

All of these structures can provide the benefit of tying an employer 110 contribution directly to something of value for the employer 110. Each of these structures may optionally be subject to employee 120 contribution in some way. For example, an employer 110 contribution may be subject to an employee 120 having contributed more than $5 to their ESA in the prior month, or more than $100 since inception. PLSS 140 may also operate such that the employer 110 contribution would be paid only after the employer 110 has already achieved the outcome of value, and may be set at an amount lower than the value accrued to the business from having achieved that outcome. Thus, the net contribution for the employer 110 is structurally positive, incentivizing employer 110 uptake and participation.

For example, consider employee 120 retention. If an employer 110 has average retention periods for employees 120 of 30 days, a reward structure could provide an employer 110 contribution to all employees 120 who are (a) employed at day 60, and (b) have contributed any amount to PLSS 140 account within the last two pay cycles. For the employer 110, the value of this reward payment could be less than the value accrued to the organization by having retained that particular employee 120 for longer than the average (and thus expected) retention period, thus ensuring that any payment of a reward under this structure remains bottom-line net positive for the organization. And for the employee 120, this incentive structure aligns the value they create for their employer 110 with the ways in which they are rewarded.

This is a key differentiator with respect to conventional systems in the market, which reward employees simply for “hours worked,” or other metrics that are not directly tied to costs for the employer, amounting to a pay increase for the employee across all hours. Such programs generate returns that must be contextualized and are only observed in the long-term. A KPI-linked employer contribution is inherently an immediate reflection of value delivered.

Moreover, in some embodiments, the diversity of reward types available in PLSS 140 may allow rewards to be funded by third parties other than the employer 110. For example, a nonprofit foundation or government, insurance provider, or other initiative may choose to provide reward payments to enrollees in a particular area based on any of the criteria above or others not yet considered.

When employer-sponsored rewards are available-whether for meeting a specific goal in daily work, or as a result of exceptional commitment to the organization (e.g., picking up available shifts)—some embodiments of PLSS 140 can provide a tracker or other visibility via employee UI 142a as to employee(s) 120 completion of those rewards. For example, if an employee 120 must sell 6 bottles of wine to achieve a reward, employee UI 142a might show a pie chart or infographic representing the current progress toward this goal depicted as the number of bottles sold versus the goal of selling 6 bottles.

In addition, some embodiments of PLSS 140 may provide proactive notification to the employee(s) 120 about the available rewards. This notification may arrive via the Employee UI 142, but also via a smartphone push notification, a phone call, a Short Messaging Service (SMS) message, electronic mail (e-mail), or any other similar distribution means. The goal of this notification is to notify employee(s) 120 about the additional earning opportunity such that they may be more likely to complete the desired action. In still other embodiments, this notification may be tied to, customized through, or powered by the planning and advisory logic 145. Employers 110 and employees 120 may both be able to control the behavior of these notifications using the employee UI 142 and employer UI 144.

Referring again to FIG. 2, the data to determine whether KPIs have been met can be obtained from other employer 110 systems (HRIS 112, payroll 114, KPI 116). For example, employee on-time performance might be automatically imported by KPI tracking module 116 from the timecard system (or related data in HRIS 112 or payroll system 114). In another example, the data to determine sales performance might be automatically imported from a point-of-sale system in a restaurant or store to KPI tracking module 116. In some embodiments, this can be facilitated by, via, or in coordinating with PLSS 140 and related API(s), making the data management portion easy and seamless from the perspective of employer 110.

To facilitate this, in one embodiment PLSS 140 presents to employer 110 an interface (e.g., employer UI 142b) in which employer 110 selects at least one characteristic of the performance-based incentive. This enables employer 110 to structure an incentive program according to their preferences. Employer 110 can select KPIs, corresponding metrics, and other factors and characteristics, and once configured the performance-incentive component of PLSS 140 can operate seamlessly behind the scenes, receiving or requesting (or both) data from HRIS 112, payroll system 114, and other systems, by or with KPI tracking module 116.

The KPI performance-based incentive can be at least one of the following: an amount saved in the employee 120's PLSS 140 account, a number of contributions made to the employee 120's PLSS 140 account, a savings participation of a team that includes employee 120, an employment term of employee 120, a characteristic of a peer or group of employee 120, an on-time performance of employee 120, an on-time performance of a team that includes employee 120, a sales goal attainment of employee 120 or a team that includes employee 120, an on-the-job performance metric related to performance of employee 120 or a team that includes employee 120, at least one customer service survey score or rating as achieved by employee 120 or a team that includes employee 120, a safety performance of employee 120, a safety performance of a team that includes employee 120, or a referral target met by employee 120 or a team that includes employee 120.

Another advantage of PLSS 140 that builds upon this is that PLSS 140 can give employers 110 the ability to test or trial various rewards across employee 120 subgroups. This can enable a particular employer 110 to customize rewards that work for different employee 120 groups or areas, further contributing to both employee 120 contributions and employer 110 bottom line. For example, an employer 110 with multiple divisions, sites, offices, levels, management chains, or other groups could use PLSS 140 to run a number of different employee 120 rewards or incentives with varying structures, weights, amounts, and vesting periods. In such an embodiment, any site or office could run their incentive structure alongside peers as a split test. An algorithm of PLSS 140 then could analyze the associated data, generating insights that employers 110 could use to refine program design for the broader employee 120 population.

Over the long term, this provides for tracking of employee 120 contributions to build a profile in PLSS 140. Eventually, PLSS 140 can become a platform for tracking the value that an employee 120 creates for employers 110 throughout their career. Such a record could reside directly within PLSS 140 in one or more proprietary or standardized formats. In one embodiment, the record could be made available securely to employer 110 or to other employers, vendors, or others, via blockchain or a similar technology. These methods allow for sharing and use across myriad purposes, including recruiting, lending, advertising, and more. Sharing positive long-term data for employees 120 could have advantages, but employers 110 would also benefit, creating a net-positive, win-win scenario.

Specifically, in some embodiments, individuals and groups of employees 120 may benefit from PLSS 140 for lending. PLSS 140 may provide two advantages over traditional creditors: (1) PLSS 140 has access to payment history for each individual, potentially across many employers 110, building a source of an alternative credit record; and (2) PLSS 140 has direct access to paycheck of an employee 120, allowing a higher likelihood and priority of funds disbursement versus a payment downstream of the checking account of the employee 120.

Moreover, in some circumstances PLSS 140 may use data from one or from many employers 110 and PLSS 140 paycheck positionality to bargain collectively with providers of services or collectors of debt. In such an arrangement, PLSS 140 may use data like the above to negotiate reduced fees, more accommodating payment schedules, lower interest rates, or other benefits to the employee 120 payor in return for a higher priority in payment and a higher likelihood of receiving funds from the creditor, collector, or other payee.

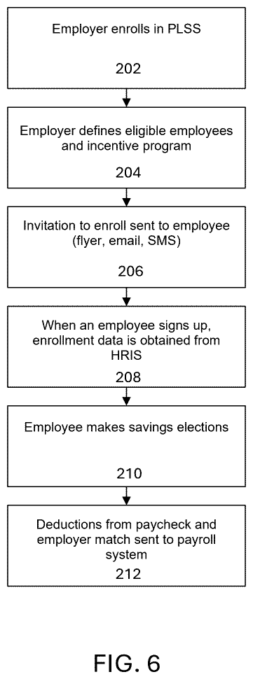

In addition to PLSS 140 and the various system embodiments discussed herein above, this disclosure also includes related methods. Referring to FIG. 6, operations of a method of implementing a PLSS are depicted. At 202, an employer enrolls with PLSS 140, and 204 the employer defines which employees are eligible to use PLSS 140 and which (if any) incentive program the employer will implement. AS part of defining the incentive program, the employer can specify KPIs for a particular employee or a group of employees. At 206, an invitation is sent by PLSS 140 to the eligible employee(s), which can be done by email, mail, text/SMS, flyer, or in some other way. When an employee accepts the invitation, necessary enrollment data and information can be obtained by PLSS 140 from the employer HRIS or payroll system, at 208. Once enrolled, the employee then can make their contribution elections in PLSS 140, at 210. At 212, the deduction(s) specified by the employee at 210 are deducted from their paycheck and deposited in the employee's account PLSS 140, and any incentive or employer match due at the time is also sent to the employee's account.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

It should be understood that the individual operations used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A computer-implemented system for workforce management comprising:
at least one processor and memory comprising code configured to facilitate a payroll-linked savings system by:
automatically identifying at least one workforce member eligible for the payroll-linked savings system in a workforce information system,
authenticating the at least one eligible workforce member for enrollment in the payroll-linked savings system and establishing an account for the at least one eligible workforce member,
presenting at least one possible contribution model to the at least one eligible workforce member,
receiving a contribution election from the at least one eligible workforce member,
diverting compensation of the at least one eligible workforce member to the established account according to the received contribution election, and
offering a performance-based incentive to the at least one eligible workforce member, such that if performance is met by the at least one eligible workforce member, a contribution is made to the established account of the at least one workforce member by an employer.

2. The system of claim 1, wherein automatically identifying at least one workforce member eligible for the payroll-linked savings system in a workforce information system comprises obtaining information about the at least one workforce member from at least one of a human resources information system or a payroll system.

3. The system of claim 2, wherein authenticating the at least one eligible workforce member for enrollment in the payroll-linked savings system comprises contacting the at least one eligible workforce member using information obtained from the human resources information system or the payroll system.

4. The system of claim 1, wherein establishing the account for the at least one eligible workforce member comprises opening at least one of a savings account or a checking account with at least one financial institution.

5. The system of claim 1, wherein presenting at least one possible contribution model to the at least one eligible workforce member comprises presenting at least one of the following for the at least one eligible workforce member: a model of contribution amounts using historical payroll data; a model of possible annualized contributions with predicted hours to be worked; a model of a value of various contribution amounts alongside at least one of outstanding debt, investments, or another asset; an estimated amount of contribution in a next pay period; an estimated amount of contribution over a remainder of a year, based on an averaged total pay per period for the year to-date; an estimated purchasing power of a contribution against a future need; or a model impact of any contribution scenario on an overall financial status.

6. The system of claim 1, wherein the code is further configured to facilitate the payroll-linked savings system by receiving information from at least one other financial system used by the at least one eligible workforce member, wherein presenting at least one possible contribution model to the at least one eligible workforce member further comprises considering the received information from the at least one other financial system in the at least one possible contribution model.

7. The system of claim 1, wherein the code is further configured to facilitate the payroll-linked savings system by:
receiving, from the at least one eligible workforce member, information about a possible withdrawal from the established account; and
presenting information about at least one impact of the possible withdrawal on a financial status of the at least one eligible workforce member.

8. The system of claim 1, wherein diverting compensation of the at least one eligible workforce member to the established account according to the received contribution election further comprises automatically routing a portion of the diverted compensation to at least one financial obligation or account in addition to the established account.

9. The system of claim 1, wherein the code is further configured to facilitate the payroll-linked savings system by:
presenting a user interface via which an employer of the at least one eligible workforce member selects at least one characteristic of the performance-based incentive.

10. The system of claim 9, wherein the code is further configured to facilitate the payroll-linked savings system by:
automatically receiving data about performance of the at least one eligible workforce member with respect to the at least one characteristic of the performance-based incentive.

11. The system of claim 10, wherein the data is automatically received from at least one of the workforce information system or an external third-party system.

12. The system of claim 9, wherein the performance-based incentive is at least one of the following and is related to the at least one eligible employee or a group that includes the at least one eligible employee: an amount saved in the established savings account, a number of contributions made to the established savings account, participation in the payroll-linked savings system, an employment term or milestone, at attendance record, a characteristic of a peer, a characteristic of on-the-job performance, an on-time performance, a sales goal attainment, achievement of an on-the-job performance metric, at least one customer service survey score or rating achieved, a safety performance, a referral target met, a quantitative or qualitative goal attainment, a participation status or achievement status in a workplace wellness program, a participation status or achievement status in a training or skills advancement program.

13. The system of claim 1, wherein the code is further configured to facilitate a payroll-linked savings system by:
running an evaluation of possible incentives across at least one pool of eligible employees to identify a most effective or most impactful performance-based incentive to offer.

14. The system of claim 1, wherein the code is further configured to facilitate the payroll-linked savings system by:
presenting a user interface via which the at least one eligible workforce member interacts with the payroll-linked savings system,
wherein presenting the at least one possible contribution model to the at least one eligible workforce member is done via the user interface.

15. The system of claim 14, wherein the code is further configured to facilitate a payroll-linked savings system by doing at least one of:
presenting, to the at least one eligible workforce member via the user interface, a contribution comparison with at least one other workforce member participating in the payroll-linked savings system; or
presenting, to the at least one eligible workforce member via the user interface, a progress status towards at least one financial goal or performance-based incentive.

16. The system of claim 1, wherein the code is further configured to facilitate the payroll-linked savings system by:
automatically adjusting the compensation diverted based on a change in the compensation of the at least one eligible workforce member.

17. The system of claim 1, wherein the code is further configured to facilitate a payroll-linked savings system by:
facilitating lending to the at least one eligible workforce member based on data related to at least one of payroll history or participation of the at least one eligible workforce member in the payroll-linked savings system.

18. The system of claim 1, wherein the code is further configured to facilitate a payroll-linked savings system by:
negotiating at least one financial transaction with an external third party based on data related to a plurality of workforce members participating in the payroll-linked savings system.

19. The system of claim 1, wherein the code is further configured to facilitate a payroll-linked savings system by:
offering a performance-based incentive to the at least one eligible workforce member, such that if performance is met by the at least one eligible workforce member, a contribution is made to the established account of the at least one workforce member by an external third party.

20. The system of claim 19, wherein the performance-based incentive is related to hours or a schedule worked or selected to be worked by the at least eligible workforce member.

21. A computer-implemented method for workforce management by facilitating a payroll-linked savings system that utilizes at least one processor and memory, the method comprising:
receiving an automatic identification at least one workforce member eligible for the payroll-linked savings system from an employer workforce information system;
authenticating the at least one eligible workforce member for enrollment in the payroll-linked savings system;
causing an account for the at least one eligible workforce member to be established;
presenting at least one possible contribution model to the at least one eligible workforce member;
receiving a contribution election for the at least one eligible workforce member;
causing compensation of the at least one eligible workforce member to be diverted to the established account according to the received contribution election, and
facilitating presentation of a performance-based incentive to the at least one eligible workforce member, such that if performance is met by the at least one eligible workforce member, a contribution is made to the established account of the at least one workforce member by an employer.

22. The method of claim 21, wherein receiving the automatic identification of at least one workforce member eligible for the payroll-linked savings system in a workforce information system comprises obtaining information about the at least one workforce member from at least one of a human resources information system or a payroll system.

23. The method of claim 22, wherein authenticating the at least one eligible workforce member for enrollment in the payroll-linked savings system comprises contacting the at least one eligible workforce member using information obtained from the human resources information system or the payroll system.

24. The method of claim 21, wherein causing the account for the at least one eligible workforce member to be established comprises opening at least one of a savings account or a checking account with at least one financial institution.

25. The method of claim 21, wherein presenting at least one possible contribution model to the at least one eligible workforce member comprises presenting at least one of the following for the at least one eligible workforce member: a model of contribution amounts using historical payroll data; a model of possible annualized contributions with predicted hours to be worked; a model of a value of various contribution amounts alongside at least one of outstanding debt, investments, or another asset; an estimated amount of contribution in a next pay period; an estimated amount of contribution over a remainder of a year, based on an averaged total pay per period for the year to-date; an estimated purchasing power of a contribution against a future need; or a model impact of any contribution scenario on an overall financial status.

26. The method of claim 21, further comprising receiving information from at least one other financial system used by the at least one eligible workforce member, wherein presenting at least one possible contribution model to the at least one eligible workforce member further comprises considering the received information from the at least one other financial system in the at least one possible contribution model.

27. The method of claim 21, further comprising:
receiving, from the at least one eligible workforce member, information about a possible withdrawal from the established account; and
presenting information about at least one impact of the possible withdrawal on a financial status of the at least one eligible workforce member.

28. The method of claim 21, wherein causing compensation of the at least one eligible workforce member to be diverted to the established account according to the received contribution election further comprises causing automatic routing of a portion of the diverted compensation to at least one financial obligation or account in addition to the established account.

29. The method of claim 21, further comprising:
providing a user interface via which an employer of the at least one eligible workforce member selects at least one characteristic of the performance-based incentive.

30. The method of claim 29, further comprising:
automatically receiving data about performance of the at least one eligible workforce member with respect to the at least one characteristic of the performance-based incentive.

31. The method of claim 30, wherein the data is automatically received from at least one of the workforce information system or an external third-party system.

32. The method of claim 29, wherein the performance-based incentive is at least one of the following and is related to the at least one eligible employee or a group that includes the at least one eligible employee: an amount saved in the established savings account, a number of contributions made to the established savings account, participation in the payroll-linked savings system, an employment term or milestone, at attendance record, a characteristic of a peer, a characteristic of on-the-job performance, an on-time performance, a sales goal attainment, achievement of an on-the-job performance metric, at least one customer service survey score or rating achieved, a safety performance, a referral target met, a quantitative or qualitative goal attainment, a participation status or achievement status in a workplace wellness program, a participation status or achievement status in a training or skills advancement program.

33. The method of claim 21, further comprising:
running an evaluation of possible incentives across at least one pool of eligible employees to identify a most effective or most impactful performance-based incentive to offer.

34. The method of claim 21, further comprising:
providing a user interface via which the at least one eligible workforce member interacts with the payroll-linked savings system,
wherein presenting the at least one possible contribution model to the at least one eligible workforce member is done via the user interface.

35. The method of claim 34, further comprising:
presenting, to the at least one eligible workforce member via the user interface, a contribution comparison with at least one other workforce member participating in the payroll-linked savings system; or
presenting, to the at least one eligible workforce member via the user interface, a progress status towards at least one financial goal or performance-based incentive.

36. The method of claim 21, further comprising:
automatically adjusting the compensation diverted based on a change in the compensation of the at least one eligible workforce member.

37. The method of claim 21, further comprising:
facilitating lending to the at least one eligible workforce member based on data related to at least one of payroll history or participation of the at least one eligible workforce member in the payroll-linked savings system.

38. The method of claim 21, further comprising:
negotiating at least one financial transaction with an external third party based on data related to a plurality of workforce members participating in the payroll-linked savings system.

39. The method of claim 21, further comprising:
offering a performance-based incentive to the at least one eligible workforce member, such that if performance is met by the at least one eligible workforce member, a contribution is made to the established account of the at least one workforce member by an external third party.

40. The method of claim 39, wherein the performance-based incentive is related to hours or a schedule worked or selected to be worked by the at least eligible workforce member.
